(19) United States
(12) Patent Application Publication
(10) Pub. No.: US 2011/0191748 A1
(43) Pub. Date: Aug. 4, 2011

(54) SYSTEMS AND METHODS FOR DESIGN TIME SERVICE VERIFICATION AND VALIDATION

(75) Inventors: Kalapriya Kannan, Bangalore (IN); Anuradha Bhamidipaty, Bangalore (IN)

(73) Assignee: International Business Machines Corporation, Armonk, NY (US)

(21) Appl. No.: 12/696,193

(22) Filed: Jan. 29, 2010

(51) Int. Cl. G06F 9/44

(52) U.S. Cl. 717/104; 717/123

(57) ABSTRACT

Design principles of services ensure reliability, scalability and reusability of software components. Services that follow the design principles are robust to changes and are largely reusable in multiple scenarios but in similar domains. To-date there is no systematic approach to apply these design principles to service design that will ensure service quality. Embodiments of the invention provide a formal check for the adherence of the services designed for an enterprise solution to the service orientation principles using design diagrams.

### BACKGROUND

Enterprises face a challenge of designing solutions that are easy to maintain. Service Oriented Architecture (SOA) has emerged as a promising solution for enterprise applications and is being widely adopted. This is primarily due to its matured and feasible design principles that provide a blueprint for architecting service components. These design principles are applied collectively to solution logic in a way that fosters key design characteristics supporting service orientation. Obtaining high quality service components is an important goal for ensuring success of SOA. However, designing high quality service components that strictly follow the design principles is not a trivial task. Moreover, validating that the service components adhere to the design principles is difficult.

### BRIEF SUMMARY

Embodiments of the invention provide systems, methods, apparatuses and program products that validate that services follow the desired principles, at design time. Embodiments of the invention provide an approach to check the adherence of the services designed for an enterprise solution to the service orientation principles using design diagrams. Embodiments of the invention utilize a set of “mapping rules” by which relevant aspects of design diagrams can be used for validating the services' adherence to principles. Thus, embodiments of the invention allow for objective, design time validation of services.

In summary, one aspect of the invention provides An apparatus comprising: one or more processors; and a computer readable storage medium having computer readable program code embodied therewith and executable by the one or more processors, the computer readable program code comprising: computer readable program code configured to interpret one or more design diagrams for one or more services and one or more service design principles to automatically generate one or more mapping rules; computer readable program code configured to apply the one or more mapping rules on the one or more design diagrams; wherein to apply the one or more mapping rule to the one or more design diagrams further comprises validating the one or more design diagrams against the one or more mapping rules generated.

Another aspect of the invention provides a method comprising: receiving one or more design diagrams for one or more services at a computer system; utilizing the computer system to interpret the one or more design diagrams and one or more service design principles to automatically generate one or more mapping rules; utilizing the computer system to apply the one or more mapping rules on the one or more design diagrams; wherein to apply the one or more mapping rule to the one or more design diagrams further comprises validating the one or more design diagrams against the one or more mapping rules generated.

A further aspect of the invention provides a computer program product comprising: a computer readable storage medium having computer readable program code embodied therewith, the computer readable program code comprising: computer readable program code configured to interpret one or more design diagrams for one or more services and one or more service design principles to automatically generate one or more mapping rules; computer readable program code configured to apply the one or more mapping rules on the one or more design diagrams; wherein to apply the one or more mapping rule to the one or more design diagrams further comprises validating the one or more design diagrams against the one or more mapping rules generated.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates two exemplary services according to an embodiment.

FIG. 2 illustrates service components according to an embodiment.

FIG. 3A-C illustrate sequence diagrams for service functionality according to an embodiment.

FIG. 4 illustrates a validation system overview according to an embodiment.

FIG. 5 illustrates application of class matching according to an embodiment.

FIG. 6 illustrates quality factors and the criteria that help achieve the quality factors.

FIG. 7 illustrates a computer system according to an embodiment

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, et cetera. In other instances, well-known structures, materials, or operations are not shown or described in detail to avoid obscuring aspects of the invention.

Currently, for enterprise Service Oriented Architecture (SOA) solutions, services are designed by software architects and therefore good design is limited by their expertise. Design defects arise from poor design choices. A design defect is an embodiment of “bad design” practice during the design phases of the services that results in services that do not follow service orientation principles. It has the effect of degrading the quality of services developed. Furthermore, there exists no systematic method to apply the design principles to software requirements or specifications. This further complicates the process of designing services that exhibit true service orientation. Lack of formal methods that map the design principles to exact service artifacts renders them as mere guidance formulas that can be used (subjectively) by the solution architects. Service artifacts are those artifacts (typically available from the design diagrams) that are directly related to the realization of the service. Therefore defects or functional faults may be induced during the design phases of the services.

A design defect induced in the early stages of design can cause a ripple effect in subsequent stages of development. Also, small perturbations in services after design can well lead to cumulative effects that affect the maintenance of the software. Early detection of service design faults is important in order to reduce the cumulative effect. A service design free of design defects is easier to implement, change and maintain. However, service design defects have not been precisely specified and there are few appropriate methods that allow their detection. Accordingly, embodiments of the invention provide a systematic approach to specifying design defects precisely. In addition, embodiments of the invention generate detection processes that can capture the design defects at an early stage.

The importance of early design defect identification has been brought out by past research works. The issue of identifying design defects commonly referred to as “bad smells” have been addressed largely in the context of object oriented programs. Service orientation is a design paradigm that has emerged recently for software development. It focuses on providing principles that ensure reliable, reusable and robust software design and development. Embodiments of the invention operate along the existing lines of detecting design defects for systems that follow service orientation architectures.

Although SOA is becoming an increasingly popular choice for the implementation of enterprise software, service-oriented (SO) design concepts are not well understood and documented. Furthermore, very little emphasis is provided in defining formal methods for applying these design principles at design time. Therefore, SO systems are often developed in an ad hoc fashion with little consideration given to measuring alternative design structures, thus resulting in decreased quality of the produced software especially in terms of its maintainability. Component based programs (SOA's superset) are expensive to maintain because of bad design practices and architectural drift. Thus, embodiments of the invention enhance the quality of the services designed by validating whether the design follows the service orientation principles. This helps in designing quality software.

Until now, defining service quality metrics is still in its infancy. Service quality metrics from various sources that measure the level of service orientation principles have been proposed in previous work. Some previous work concentrated on utilizing the code available for defining the quality metrics of cohesion and coupling respectively. Other previous work presents a formal method to design the services but is mostly restricted to the cohesion and coupling metrics. Embodiments of the invention, in contrast, prioritize detecting design defects at the early stages of the design process, and thus utilize design diagrams as sources of information for defining service metrics. Embodiments of the invention utilize design diagrams to provide metrics that validate the quality of the services designed.

Some proposed processes and techniques to detect design defects exist, yet the inventors have recognized that they have several limitations in the context discussed herein. Processes such as Service Litmus Test (SLT) define service granularity and can be used to validate whether services adhere to design principles. SLT has a set of criteria that helps to resolve whether a candidate service should be exposed or not and is realized through a check list process. Using SLT, service quality is assessed by architects through a manual verification process of the individual items in the checklist. Therefore, SLT still remains a heuristic method for identifying design defects, reliant on the user's personal expertise.

In contrast, embodiments of the invention utilize rules developed to capture the deviations from good design principles and heuristics. In this description is presented a non-limiting and exemplary approach to validate whether the services adhere to the design principles. The design diagrams for all information representing implementation and environmental artifacts of services are investigated and analyzed. As a result, the key UML diagrams that are required for identifying faults in the design are identified. The mapping of service orientation principles to implementation and environmental artifacts present in the UML diagrams is explored. Moreover, processes for extracting the service artifacts from UML diagrams are presented, as well as their use for verification of the design. A verification process is evaluated on a set of real world examples against human design.

Embodiments of the invention exploit sources of knowledge that can provide service artifacts which when extracted can be used for detecting design defects. One such source is the low-level design diagrams, for example Unified Model Language (UML) diagrams, concerned with representation of all implementation and environmental software artifacts related to services. Implementation artifacts are those that are required for implementing the services, such as messages exchanged; objects required for realizing service and environmental artifacts are those that represent relationships between objects that help realization of service.

Design diagrams are developed in parallel to services' design and therefore are available during the early phases. Embodiments of the invention use UML as design diagrams as they are a de-facto standard for capturing the software artifacts. Embodiments of the invention utilize UML diagrams and analyze them via a UML interpreter for all software artifacts, extracted via an artifacts extraction engine, that are directly related to services realization.

Embodiments of the invention employ mapping rules generated via a mapping rules generator that relate the service design principles to the UML software artifacts. The validation engine according to embodiments of the invention extracts these UML software artifacts from the design diagram of the services and validates whether the input service components adhere to the design principles. An architect may input additional design principles into the validation system. If it is determined that the service is defective, that is, does not adhere to the design principles, the errors are identified for review by the user.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A case study of student course registration described in rational tutorial to the rational unified process is used as a non-limiting example.

Assume the following expectations (in terms of functionality of a service) must be met: (a) In every semester, students may request a course catalogue containing a list of course offerings for the semester. (b) The new on-line registration system will allow students to select four course offerings and two alternative choices for the coming semester. (c) No course offering will have more than ten students and less than three students. (d) Billing is done for each student for the courses registered. (e) Professors must be able to update their course offerings and see which students signed up.

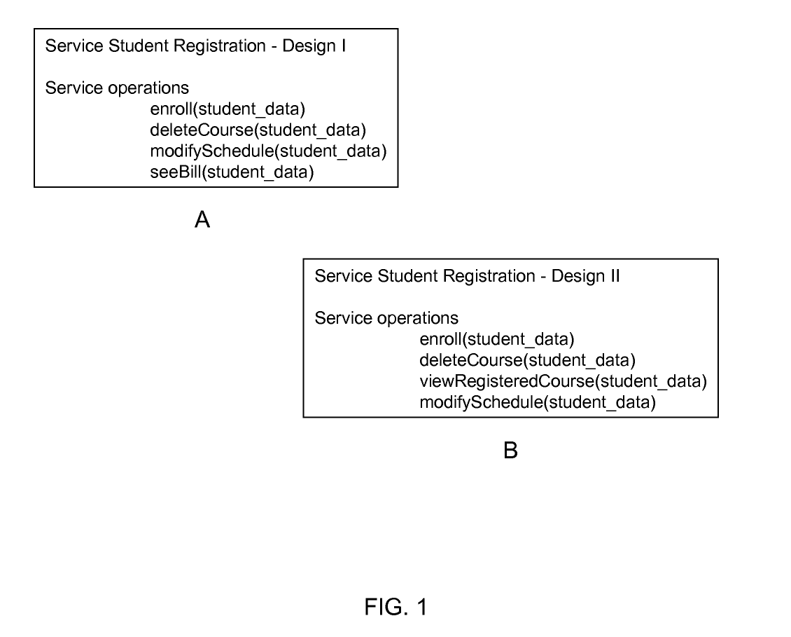

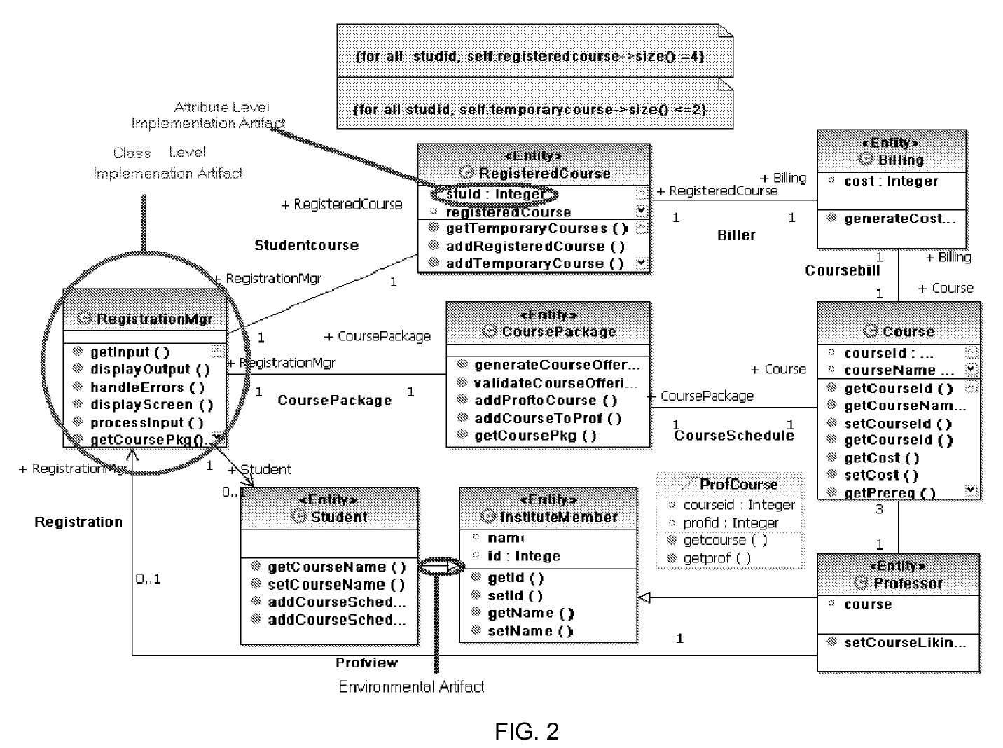

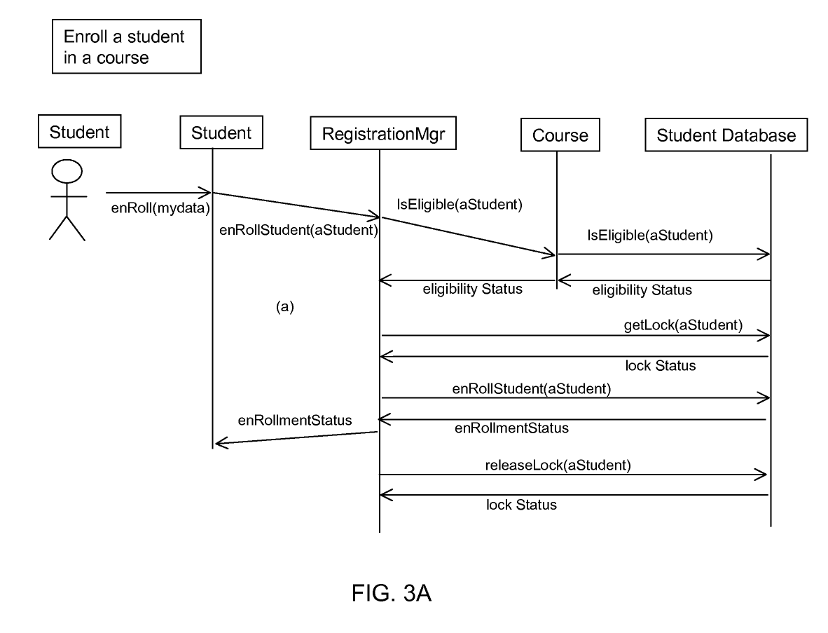

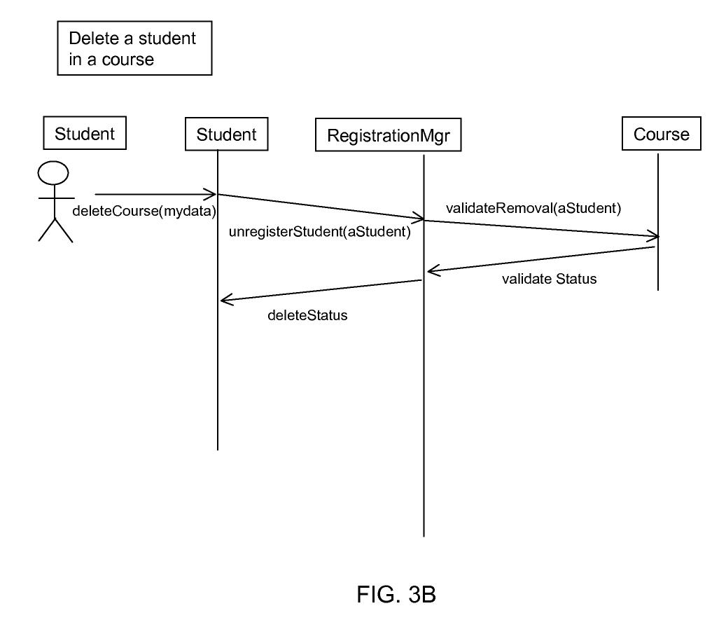

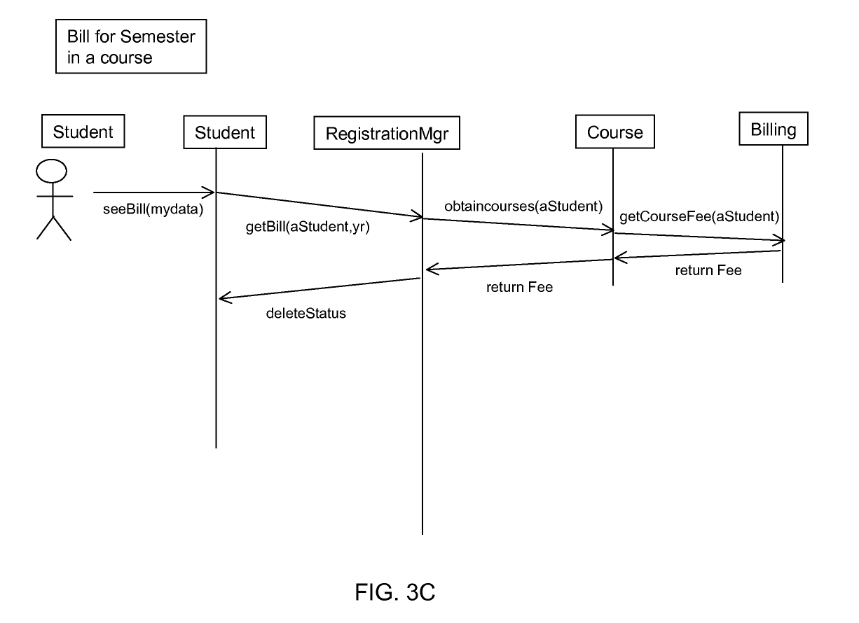

For the purpose of experimentation and evaluation, there are several services that provide a solution meeting the above expectations. FIG. 1(A-B) provides two such services that provide the desired functionality related to student registration. The two services have been designed by two different architects. As running example, the sequence diagrams shown in FIGS. 3A, B, and C have been used for the functionality “Enroll student in a course”, “Delete student in a course” and “Bill for semester”, respectively.

System Overview

A brief system overview consistent with embodiments of the invention is now presented. Service design principles like object orientation principles ensure design of services that are easy to maintain. Embodiments of the invention focus on improving the quality of the services designed. Currently industry standards (for example, Web Services Description Language (WSDL), and Web Ontology Language (OWL-S)) describe a service as a collection of operations, where an operation is defined by its signature (that is, operation name, input and output parameters and types).

The design principles involved are as follows:

1. Business Alignment: the service provides a related set of functionality. For example, a service related to student registration does not perform functionality related to professor (performing a different function).

2. Services are loosely coupled such that the overall service provides a generic interface so the dependency between two services is not present.

3. Services are composable: the service is not dependent on another service and can be composed if it matches the requirements.

4. Services are reusable: the service designed in one environment can be used for another by the same requirement.

5. Services are autonomous: the Service holds exclusively its required resources.

6. Services are stateless: the service is designed with all the required parameters available for it being passed to it, and not assumed to be an effect of the previous occurrence of the service.

Embodiments of the invention concentrate on validating service oriented principles based on the limited information that can be obtained from the design diagrams. There are two primary steps towards achieving this goal of service validation: (a) identifying UML diagrams that have service artifacts, and (b) identifying software artifacts from those diagrams that reflect service artifacts.

Identifying UML Diagrams and Software Artifacts That Have Service Artifacts

One of the main goals of the service design principles is to ensure defect-free services, resulting in minimum effect on the overall services ecosystem in a solution. The effect of one service on the other can be realized by the services behavior in the system. Those design diagrams that reflect behavioral aspects capture the service behavior in the system, especially the implementation related artifacts. Diagrams such as interaction diagrams and activity diagrams primarily represent the dynamic behavior of the system. Therefore, services are traceable through diagrams representing dynamic interactions in the system and are good sources of service artifacts. Whether static diagrams such class diagrams provide service artifacts that can be used for services validation is also explored herein.

In order to identify the service artifacts, details of the UML elements representing different aspects of software artifacts are required. UML elements can be classified broadly into two categories: (a) Implementation Artifacts: introduced by the architect of the software solution to capture those elements that represent low-level details of the solution such as messages exchanged and their behavior. Such artifacts are either full-fledged classes or specific attributes of a class. (b) Environmental Artifacts: ontological entities and relationship among such entities. Relationships include generalization (IS-A), aggregation/composition (HAS-A) and USING association. The stereotypes are used to identify UML elements. Implementation artifacts that reflect dynamic behavior contribute to service artifacts. Environmental artifacts such as IS-A, HAS-A, USING relationships and entities participating in such relationships reflect domain concepts.

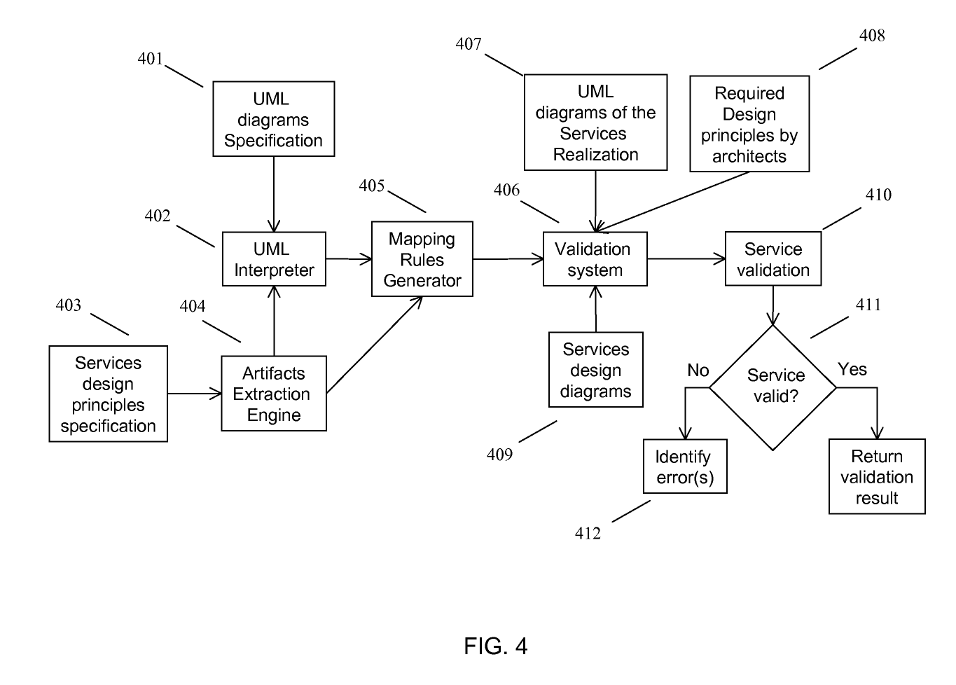

FIG. 4 illustrates a validation system according to an embodiment of the invention. A mapping rules generator (MRG) 405 utilizes the UML specifications 401 and services design principles (SDP) 403 to generate the mapping rules. The services design principles 403 provide the input and define the limiting conditions for good service orientation. The design principles 403 are in the form of grammatical constructs and should be mapped to software artifacts. The artifacts extracting engine (AEE) 404 exports the design principles 403 in a format that can be easily interpreted by the MRG 405. The UML interpreter 402 defines and extracts the service artifacts from the UML diagram 401.

MRG 405 defines a mapping rule (MR) between a set of service artifacts (typically implementation artifacts available through the dynamic interaction diagrams and associated classes) and the SDP 403. Mapping rules constitute a core of embodiments of the invention. They define the relationship between the software artifacts in the UML specification 401 to the service artifacts. Each design principle has a MR defined and therefore addition of a new design principle requires addition of a new MR. Once the MR for a design principle is created it can be used in any number of software projects that require services design and validation. The validation system (VS) 406 takes the mapping rules (MR(s)) and validates 410 whether the input service components (available through services design diagram (SDD) 409) follows the design principles. For every SDD 409 the corresponding UML diagrams 407 are taken as input by the VS 406.

Mapping of Service Artifacts to Software Artifacts in a UML Diagram

“Business Alignment” is a principle, utilized herein as a non-limiting example of a principle to be validated, that establishes the following facts about a service: 1. Whether the service provides a consistent business functionality; and 2. Whether there is a business goal that this service directly supports. Services that do not provide “a defined business goal” severely affect the ecosystem in which the services are invoked and used. This can be demonstrated through a simple example for the sample domain presented in running example introduced above.

Consider for example the sequence diagrams present in FIGS. 3A, B and C. In this service, operations “enroll”, “deleteCourse” utilize the same business objects as “Student” “RegistrationMgr” and “Course”. The service operation “seeBill” utilizes “Billing” apart from the above mentioned classes. When the service operations utilize the same set of business objects, the usability of the service is enhanced as it reduces the dependency of the operation on several business objects. Therefore, to have ideal service ecosystem, it is important to have service operations operating on a defined business goal that utilizes similar set of business objects.

Identifying the UML Diagram and Business Alignment Validation

One method by which “Business Alignment” can be validated is that the business objects (typically the environmental artifacts) are accessed uniquely and the service accesses a similar set of business objects. Similarity in the pattern of business objects utilized directly reflects the business objectives. For instance, consider a ticket booking service that has two operations: “book ticket” and “view ticket”. Both of them have the same business object utility pattern, as accessed by the user, and the same data object will store the required data. When the business object patterns are same, then it can be ensured that the service serves a set of related functionality rather than a dispersed set of functionality.

Sequence diagrams provide information about the business objects that are used for achieving each functionality in the service. For each service, all the sequence diagrams that are used for achieving all the functionality of the services are considered. As a preprocessing step, class diagrams are used to verify/populate the stereotypes for the classes in the sequence diagrams. Embodiments of the invention determine whether the sequence diagrams access the business objects uniquely and therefore business objectives are aligned.

According to embodiments of the invention, the process consists of two major steps: (a) obtaining the business objects utilized by each functionality of a service, and (b) determining whether the business objectives are aligned by evaluating the business objects are utilized in similar pattern. For sake of simplicity, two sequence diagrams are considered as a non-limiting example. However, one of ordinary skill in the art will recognize that this example can be extended to any number of sequence diagrams.

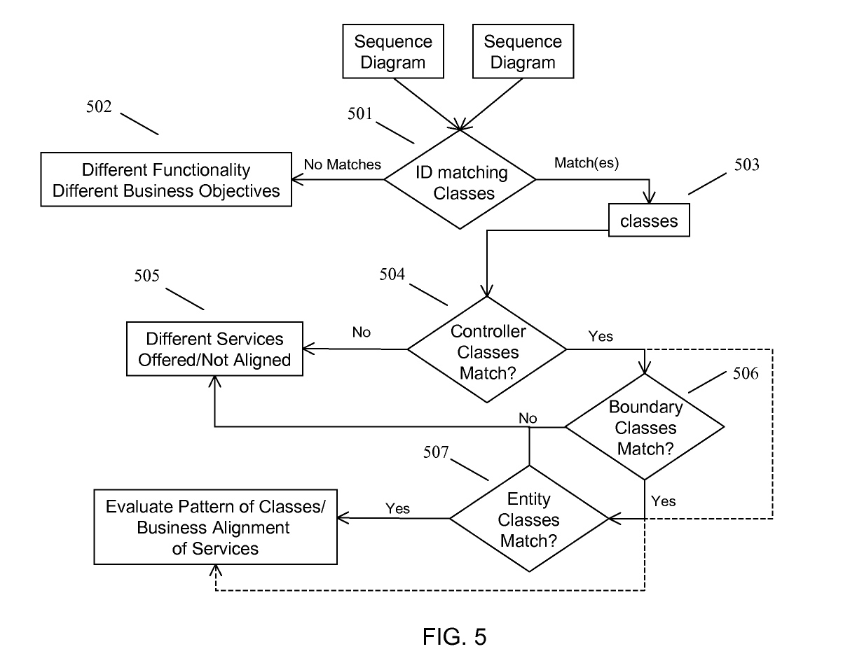

Referring to FIG. 5, as a first step, the matching classes between two sequence diagrams are identified 501. If there are no matching classes among the sequence diagrams, then each sequence diagram represent different functionality with different business objectives 502. It therefore directly implies that the service has diverse functionality. However, if the two sequence diagrams have common classes then it requires further analysis 503 on the pattern and usage of matching classes to interpret whether the functionality performed by the two sequence diagrams have business alignment.

Controller classes perform the actual operation required to achieve the functionality. Therefore, controller class plays an important role in determining if two services are performing business functionality that are related to a single business objective. Thus, it is determined if the controller classes match 504. If the common set (matching classes) do not have a matching controller class then it can be said that the two sequence diagram offer services which are distinctly different 505. In this case, the service does not align to a single business objective. For example, sequence diagrams shown in FIG. 3A and FIG. 3C do not have a matching controller class. In this case “enroll a student for a course” and “bill for semester” should be modeled as two different services.

On the other hand, business alignment of services is ensured if the following conditions are satisfied: (i) the services are requested by same boundary class 506, (ii) the services are provided by the same controller class 504 and (iii) the services use the same entity classes for storage/retrieval 507. Example of this category is FIG. 3A and FIG. 3B. In this case, “enroll a student” and “delete a student” can be modeled as two operations of a service called “student utility”.

If there exists a subset of classes that match between the two sequence diagrams, then the type (pattern) of classes and the level of matching between them determines whether business objective is aligned. Below are elaborated the different usage patterns and their usefulness in validating the business alignment criteria.

Service Consumer Usage Pattern: In a typical product usage it is likely that actors (consumers) act upon a business object for obtaining a service. For example, a student (actor) would like to add, delete, register or update her/his course (business object) details. These activities are utilized by the student and can be aligned into a single service. It follows that these operations are performed by a single controller class (towards a business logic). Therefore, if the boundary classes (service requester) and the controller classes (performs the operations) matches between the sequence diagrams, then it can be said that their business objectives can be combined.

An example of this category can be seen in FIG. 3A and FIG. 3B. The consumer of the service is the “student” (actor). The controller and boundary classes are the same. The interfaces exposed can be combined into a service with similar business objectives.

Service Producer Usage Pattern: A service is performed by the controller classes (producer) by either obtaining data or storing data to persistent objects (entity class). If the matching classes between sequence diagrams are controller and entity classes, then the services might be related and combined into a higher level abstraction. The sequence diagrams shown in FIG. 3A and FIG. 3B can be considered for this case. The controller class being the same in both cases (class “RegistrationMgr” and class “Course”), it is likely that the business objectives of these sequence diagrams are aligned.

Consumer-Storage Usage Pattern: The matching of the service requesting class and the persistent information class do not necessarily convey information about the relatedness of the services. The service requesting class can operate via a different controller to store or obtain information from the persistent objects. The operations performed by the controller class or raised by the boundary class might be entirely distinct. In this case, the two sequence diagrams do not serve a similar business objective and therefore should be modeled into two different services.

From the above discussion, a mapping rule can be summarized as follows: Mapping Rule: A service is business aligned if the following sequence diagrams of its operations satisfies the following conditions: (a) Service Provider Usage Pattern or (b) Service Consumer Usage Pattern. They are less likely to be aligned if they follow Consumer Storage Usage Pattern.

Loosely coupled: Coupling refers to a connection or relationship between two things. A measure of coupling is comparable to a level of dependency. This principle advocates the creation of a specific type of relationship within and outside of service boundaries, with a constant emphasis on reducing (“loosening”) dependencies between the service contract, its implementation, and its service consumers.

There are numerous types of coupling involved in the design of a service, each of which can impact the content and granularity of its contract. The different types of coupling are essentially as follows.

Coupling 1: The service logic can be coupled to multiple Services; it may need to be composed. Coupling 2: The service logic may be coupled to various resources that are part of the overall implementation environment. Coupling 3: The service logic will be implemented and therefore coupled to proprietary vendor technology. Coupling 4: The service contract can be coupled to the Service logic. Coupling 5: The Service logic can be coupled to the service contract. Coupling 6: The service contract and any underlying logic can be coupled to a parent business process. Coupling 7: Service consumers are coupled to the service contract.

Out of the above mentioned couplings, intra-service (coupling 1) and consumer dependencies (coupling 7) are very important, since they directly affect the quality of the services designed with respect to reusability aspect. Embodiments of the invention provide a mechanism to identify service artifacts that help in detection of these couplings.

Addressing Intra Service Coupling: One method of reducing these couplings is to allow communication between services to follow standard message based interface and speak a standard, interoperable language (for example SOAP) and data to be exchanged in a standard format like the XML. Loose coupling can be enhanced in a major way by transmitting messages through the use of a flexible file format such as XML as a means of enabling subscribers to publish clear definitions of how they subsequently use this information. This can directly be converted into a mapping rule for validating the intra service coupling.

Mapping Rule: Consider all sequence diagrams for the operations that the service provides. If all the sequence diagrams accept data (typically looked into the parameters) in a standard form such as XML, then the services might be loosely coupled.

Addressing Consumer Dependency: Another method is to employ a formal contract between the service providers and service consumers. The formal contract is through an interface. A method to reduce dependency is to effectively decouple services such that service invocation does not strictly follow any particular order. This can be achieved by reducing the data passed to the service via key data. A service, for instance, that transmits a letter is most reusable when only the customer identifier is passed and the customer address is obtained from within a service. This helps in invoking services in random order rather than specific order.

In order to identify those interfaces where the key data is passed as a parameter, embodiments of the invention examine all the operations (through service interfaces) of a service. Embodiments of the invention extract all parameters of each of the interface. If any subset of parameters is output of the same external service or data object, then it can be inferred that parameters include more than just the key data. For instance, in the running example, if the parameter to the service operation “enroll( )” was student id, student name, student validation information et cetera, then the information passed to the service is more than the key data.

In the above example, parameters belong to the same data object and therefore it can be easily identified whether a key data is passed. But a subset of parameters originating from a same external service requires service interaction diagrams. Service interaction diagrams, although not part of the UML diagrams, are also standard diagrams available during the design phases of the services. Alternatively embodiments of the invention can explore whether UML diagrams can be used to obtain such information.

Typically the key and its related data is available as part of data object. For instance, a class called “student” would be used to model a real world entity called student with id, name, validated et cetera, as its attributes. This can be exploited to obtain information about whether the key data is passed or additional data items are also passed. Consider the parameters and the data object (if the parameter is a standard data type in the data object) that the parameter represents. As class diagrams are static representation of the data objects, they can be used to identify whether the parameters belong to the same data object or not. It should also be noted that it augments the fact that as all services of the system use the same class diagram for realizing, the output data item of the services can directly be obtained in the class diagrams as static components. If there exists a subset of the parameters that represents the same data object, then tight coupling exists.

Mapping Rule: Consider all parameters of a service interface. If a subset of the parameters belongs to the same data object represented in a class (static objects), then it can be said that there exists tight coupling by defining the data order availability. Care should be taken to decouple data dependencies.

Reusable: Reusable services are characterized by the following quality factors: understandability, adaptability, portability, genericity, dependability, cohesion, independence and having well defined interfaces. Of these quality factors mentioned above, included in the description herein are those aspects related to understandability, adaptability and portability, as they are most important for reusability. These factors are selected only to provide a non-limiting and exemplary analysis of the reusability of a service. Factors related to other aspects of service quality that do not affect the reusability are not presently considered for simplicity.

The choice of the three factors affecting reusability has been made on the basis of an analysis of the activities carried out when reusing a service. These activities are as follows. 1. Understanding the functionality of the component, to decide whether it meets the new functional requirements. A user needs high understandability to do this activity. Understandability is defined based on the estimated effort needed by a user to recognize the concept behind a component and its applicability. 2. Adapting the component to the specific functional requirements of the new system. A user needs high adaptability to do this activity. Adaptability is the ease with which a component can be adapted to fulfill a requirement that differs from that for which it was originally developed. 3. Porting the component to a new environment. A user needs high portability to do this activity. Portability is the ease with which software can be transferred from one environment to another.

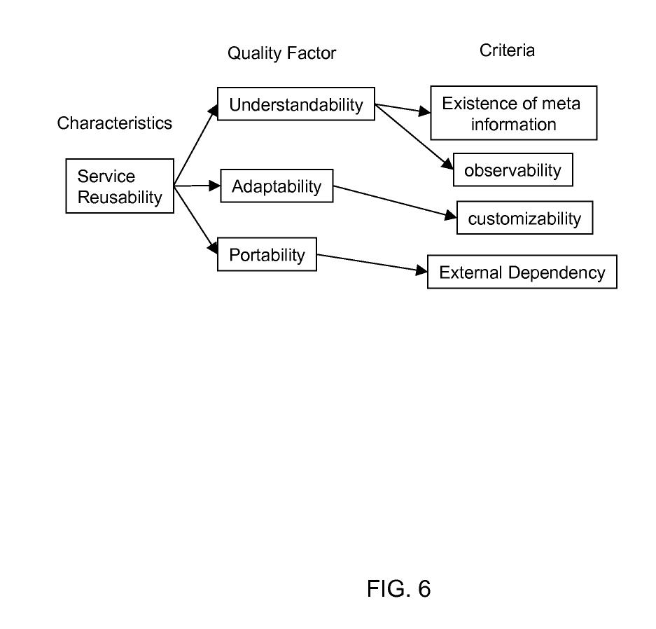

FIG. 6 shows the quality factors and the criteria that helps in achieving the quality factor. Each of these parameters is briefly described below.

Understandability: Two criteria that help in the understandability are the existence of the meta-information describing the complete functionality of the service and observability.

Existence of meta-information: This is available from the documents (with complete details) provided along with the services either as meta information or as supplements. Consider for example EMI represents the Existence of Meta Information. Then equation 1 gives the EMI depending on whether the design diagrams and its corresponding documents are available.

$$E M I ≡ \{ \begin{matrix}1 Documents are available \\ 0 Documents are not available\end{matrix} \}$$

Mapping Rule: If the value of the EMI is 1 then the users of the service can easily understand the usage of the Service. In the example of student registration, the understandability is increased when the document explaining the functional details (not how it achieves them) is available.

Observability: In addition to the documents, it is important that the parameters of the services are clearly readable, understandable and follow the required nomenclature. In order to reuse the services better, the input and the output parameters should follow the nomenclature in a manner that clearly reflects the importance of the parameter, which can directly be converted to the rule.

Mapping Rule: Consider all sequence diagrams of the operations and its parameters. Validate if the parameter follows the required nomenclature and is readable. If they are, then it is considered to be observable.

Adaptability: Adaptability is defined as the ease with which a service can accommodate to change and the ability to integrate new functionality easily. A well-designed service should have built-in capability for supporting customization and configuration of its internal functional features. Service functionality is utilized by invoking individual service operations. Each time a service operation is added to the existing service, it needs to be validated against all these service orientation principles.

Portability: Portability is defined as the ability of the service to operate on a wide variety of computer platforms with little modifications, if required. External dependency is one factor that affects that portability to a large extent. External dependency indicates the service's degree of independence from the rest of the software that originally used the software. The external dependency can be captured in terms of its pre-conditions. Services can be easily ported when the number of their requirements in terms of parameter is minimal and it performs a well-defined functionality with these minimal requirements. If the pre-condition for invoking the services operations is reduced minimum number of parameters (typically not more than 2), then the portability can be easily achieved. This can be specified as a mapping rule.

Mapping Rule: Consider a set of sequence diagrams; if the pre-condition is restricted to 1 or 2 parameters, then the external dependence is minimal.

Autonomous: Autonomous refers to an entity being self-governing, independent and not controlled by outside forces. A service being autonomous would translate to it having ownership and control over all used components and resources. In practice, there could be varying levels of autonomy, one in which a service owns and controls all resources it needs, to another in which it controls only some of the resources and a third one in which a service has only shared access to the resources. Access and control of shared resources is usually driven by a formal contract.

To verify if a service adheres to a contract in its communication with shared resources is not further described herein. For the purposes of this description, the focus is to validate if a service is designed to work in an autonomous fashion. For a service to be completely autonomous, it would require to have exclusive access to the resources it uses. As the level of access moves from exclusive to shared, the level of autonomy decreases. Validating the autonomy of a service can be done by checking the nature of access a service has to the resources and components it uses.

Sequence diagrams describe the interaction of a service with its components and resources. Embodiments of the invention use the sequence diagrams to validate the autonomous property of a service at design time. FIG. 3A shows the interaction between various components involved in enrolling a student. The course object interacts with the student database to find the enrollment eligibility of a student and if eligible the student is enrolled. Embodiments of the invention can analyze the communication between the RegistrationMgr and the student database to evaluate the autonomy of the “Enroll a Student” function. As shown in FIG. 3A, the RegistrationMgr gets an exclusive lock on the student object to change the enrollment status. This guarantees an exclusive access of the student database and makes it independent of other objects in the system trying to access the same resource. Thus, the function is designed in an autonomous way, as it is able to control the output of the resource avoiding unpredictable behavior.

Autonomy of a service can also be examined in the environment it is being executed. This would involve comparing a service with other services which are operating in the same environment and analyzing their communications with shared resources, if any. It is not always practical to assume information of other services being available during design time. Thus, the description provided herein focuses on validating a service against the service orientation principles given its design diagrams.

Sequence diagrams provide the best information towards understanding the autonomy of the service. One can choose to quantify the autonomy by examining the number of resources that are accessed in an exclusive way over the total number of resources a service accesses. For example, if a service accesses 10 resources and 8 of them are accessed exclusively, then the autonomy score is 8/10 or 80%.

Mapping Rule: Consider the interactions of a service with its resources to identify if the resource is being accessed in an exclusive manner. If not, there is a possibility of unpredictable output and dependency on its environment and hence may be less autonomous.

Stateless: Stateless as defined herein means that the service need not know anything about the consumer and their history and preferences. This implies that the service cannot hold information “within” in between interactions with the consumer. The keyword here is “within”; if information is held in a database and the data is committed, it is no longer “within” the service. The next interaction can go to the database and retrieve the information. What must not happen is that threads or locks are held by the service between requests from the consumer.

Information about the accesses done by a service is available in the sequence diagrams of the service operations. A service is supposed to be stateless if the service utilizes external references for accessing persistent data like database, file or persistent objects. The access to these external persistent storage elements should be done by obtaining a lock and the lock should be released after the access. Furthermore, if there exists global or static data objects (which are for specific invocations of the service) that the service uses to store data elements then it can be said that service is stateful and care should be taken to avoid such situations.

Mapping Rule: To determine whether services are stateless, consider the interaction diagrams of a service. If no global or static data object is utilized for storing data, then the service may be stateless. Furthermore, data requirements should be fulfilled by external persistent references such as database, files, et cetera.

Validation Engine: The validation engine utilizes the mapping rules and applies it on specific design diagrams and their services and validates whether the services follow the design diagram principles. The framework also provides provisions for the architect to select a subset of principles for a given design and validate the services against them. For instance, an architect can choose to validate loose coupling and stateless nature of the services and corresponding mapping rules are utilized. By providing the mapping rules, the validation engine identifies defects (those services that do not follow design principles) at an early stage.

Embodiments of the invention provide a framework by which different Service Orientation Principles can be validated for a specific service design. In some cases, the definition of the principle is broad enough that more than one mapping rule is required to validate them. Also there might be instances when multiple rules are available and only a subset of rules is valid depending on the service design. It might also occur that a principle might assume different definitions as uniquely understood.

Thus, the non-limiting and exemplary embodiments of the invention discussed herein address an important problem of validating services and identifying design defects at an early stage. UML diagrams encapsulate service artifacts, which when extracted can be used for validation purposes. Embodiments of the invention provide and apply mapping rules that map the software artifacts present in UML to service artifacts. These mapping rules are defined once and can be reused for any number of validations of services' design. Embodiments of the invention therefore provide a complete framework for defining new principles and also provide provisions for defining new mapping rules. These mapping rules will significantly reduce the effort required in detecting faults. Experimental results indicate that embodiments of the invention are of great benefit to people involved in design of services.

It will be readily understood by those having ordinary skill in the art that embodiments of the invention may be implemented using one or more computer systems. In this regard, a non-limiting and exemplary computer system is described herein.

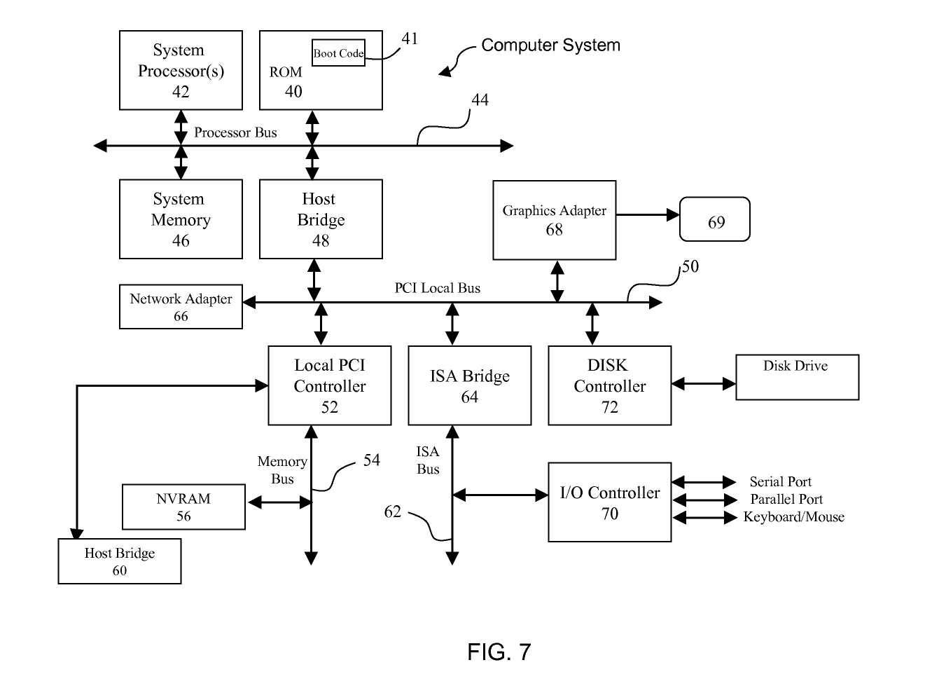

Referring now to FIG. 7, there is depicted a block diagram of an illustrative embodiment of a computer system. The illustrative embodiment depicted in FIG. 7 may be an electronic device such as a laptop or desktop personal computer. As is apparent from the description, however, the embodiments of the invention may be implemented in any appropriately configured device, as described herein.

As shown in FIG. 7, computer system includes at least one system processor 42, which is coupled to a Read-Only Memory (ROM) 40 and a system memory 46 by a processor bus 44. System processor 42, which may comprise one of the AMD line of processors produced by AMD Corporation or a processor produced by INTEL Corporation, is a general-purpose processor that executes boot code 41 stored within ROM 40 at power-on and thereafter processes data under the control of an operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system to LAN, and graphics adapter 68, which interfaces computer system to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system further includes Industry Standard Architecture (ISA) bus 62, which is coupled to PCI local bus 50 by ISA bridge 64. Coupled to ISA bus 62 is an input/output (I/O) controller 70, which controls communication between computer system and attached peripheral devices such as a as a keyboard, mouse, serial and parallel ports, et cetera. A disk controller 72 connects a disk drive with PCI local bus 50. The USB Bus and USB Controller (not shown) are part of the Local PCI controller (52).

It should be noted as well that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. An apparatus comprising:
one or more processors; and
a computer readable storage medium having computer readable program code embodied therewith and executable by the one or more processors, the computer readable program code comprising:
computer readable program code configured to interpret one or more design diagrams for one or more services and one or more service design principles to automatically generate one or more mapping rules;
computer readable program code configured to apply the one or more mapping rules on the one or more design diagrams;
wherein to apply the one or more mapping rule to the one or more design diagrams further comprises validating the one or more design diagrams against the one or more mapping rules generated.

2. The apparatus according to claim 1, wherein the computer readable program code further comprises computer readable program code configured to identify one or more design defects in response to validating the one or more design diagrams against the one or more mapping rules generated.

3. The apparatus according to claim 2, further comprising:
a display device; and
wherein the computer readable program code further comprises computer readable program code configured to output one or more validation suggestions for correcting to the one or more design defects.

4. The apparatus according to claim 1, wherein the one or more design diagrams comprise Unified Modeling Language diagrams.

5. The apparatus according to claim 1, wherein the computer readable program code configured to interpret one or more design diagrams and one or more service design principles to generate one or more mapping rules is further configured to extract one or more artifacts.

6. The apparatus according to claim 1, wherein validating the one or more design diagrams against the one or more mapping rules generated comprises comparing one or more classes extracted from two or more design diagrams.

7. The apparatus according to claim 6, wherein the one or more classes comprise one or more of a controller class, a boundary class, and an entity class.

8. The apparatus according to claim 1, wherein the one or more services comprise one or more software services.

9. The apparatus according to claim 1, further comprising:
one or more user interfaces; and
wherein the computer readable program code further comprises computer readable program code configured to apply to the validation one or more required design principles input by a user via the one or more user interfaces.

10. A method comprising:
receiving one or more design diagrams for one or more services at a computer system;
utilizing the computer system to interpret the one or more design diagrams and one or more service design principles to automatically generate one or more mapping rules;
utilizing the computer system to apply the one or more mapping rules on the one or more design diagrams;
wherein to apply the one or more mapping rule to the one or more design diagrams further comprises validating the one or more design diagrams against the one or more mapping rules generated.

11. The method according to claim 10, further comprising utilizing the computer system to identify one or more design defects in response to validating the one or more design diagrams against the one or more mapping rules generated.

12. The method according to claim 11, further comprising outputting to a display device one or more validation suggestions for correcting to the one or more design defects.

13. The method according to claim 10, wherein the one or more design diagrams comprise Unified Modeling Language diagrams.

14. The method according to claim 10, wherein utilizing the computer system to interpret the one or more design diagrams and one or more service design principles to automatically generate one or more mapping rules further comprises extracting one or more artifacts.

15. The method according to claim 10, wherein validating the one or more design diagrams against the one or more mapping rules generated comprises comparing one or more classes extracted from two or more design diagrams.

16. The method according to claim 15, wherein the one or more classes comprise one or more of a controller class, a boundary class, and an entity class.

17. The method according to claim 10, wherein the one or more services comprise one or more software services.

18. The method according to claim 10, wherein further comprising accepting one or more one or more required design principles input by a user via one or more user interfaces to apply to the validating.

19. A computer program product comprising:
a computer readable storage medium having computer readable program code embodied therewith, the computer readable program code comprising:
computer readable program code configured to interpret one or more design diagrams for one or more services and one or more service design principles to automatically generate one or more mapping rules;
computer readable program code configured to apply the one or more mapping rules on the one or more design diagrams;
wherein to apply the one or more mapping rule to the one or more design diagrams further comprises validating the one or more design diagrams against the one or more mapping rules generated.
